(19) United States
(12) Patent Application Publication
(10) Pub. No.: US 2009/0110986 A1
(43) Pub. Date: Apr. 30, 2009

(54) Method and apparatus for managing fuel cell performance and direct methanol type fuel cell using the method

(76) Inventors: Bo-Geum Choi, Suwon-si (KR); Jun-Young Park, Suwon-si (KR); Jin-Hwa Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/215,100

(22) Filed: Jun. 24, 2008

(30) Foreign Application Priority Data
Oct. 30, 2007 (KR) 10-2007-0109799

(51) Int. Cl. H01M 8/04

(52) U.S. Cl. 429/23; 429/14

(57) ABSTRACT

The present embodiments relate to a method and an apparatus for managing fuel cell performance and a direct methanol type fuel cell using the method, capable of setting an activation time point to a user's use time point and spontaneously performing performance recovery during long time use thereof.

The method for managing performance of the fuel cell stack according to the present embodiments includes the steps of: receiving a first drive request signal or a performance recovery request signal; circulating high-concentration liquid fuel having higher density than fuel supplied to a stack through an anode flow of the fuel cell stack in response to the received request signal; and circulating water through the anode flow after stopping the circulation of the high-concentration liquid fuel.

### CROSS-REFERENCE TO RELATED APPLICATIONS

This application claims priority to and the benefit of Korean Patent Application No. 10-2007-0109799 filed on Oct. 30, 2007, in the Korean Intellectual Property Office, the entire content of which is incorporated herein by reference.

### BACKGROUND OF THE INVENTION

1. Field of the Invention

The present embodiments relate to a method and an apparatus for managing fuel cell performance and a direct methanol type fuel cell using the method, capable of setting a first activation time point to a user's use time point and spontaneously performing performance recovery during long time use thereof.

2. Description of the Related Art

Since a fuel cell is a virtually pollution-free power supply apparatus, it has been spotlighted as one of the next generation clean energy power generation systems. It has advantages that the power generation system using the fuel cell can be used in a self-generator for a large building, a power supply for an electric vehicle, a portable power supply, etc. and can use various fuels such as natural gas, city gas, naphtha, methanol, waste gas, etc. The fuel cell is sorted into a molten carbonate fuel cell (MCFC), a solid oxide fuel cell (SOFC), a polymer electrolyte membrane fuel cell (PEFC), a phosphoric acid fuel cell (PAFC), an alkaline fuel cell (AFC), etc., in accordance with the electrolyte used.

Among others, the polymer electrolyte fuel cell is sorted into a polymer electrolyte membrane fuel cell (PEMFC) or a proton exchange membrane fuel cell and a direct methanol fuel cell (DMFC) in accordance with fuel used.

The polymer electrolyte membrane fuel cell uses a solid polymer as the electrolyte. Therefore, it has no risk of corrosion or evaporation due to the electrolyte and can obtain high current density per unit area. Moreover, since the polymer electrolyte membrane fuel cell is very high in output characteristic and low in an operating temperature as compared to other kinds of fuel cells, it can be widely used. For example, it has been actively developed as a portable power supply for supplying power to a vehicle, etc., a distributed power supply for supplying power to a house or a public building, etc., and a small power supply for supplying power to electronic equipment, etc.

The direct methanol type fuel cell directly uses liquid-phase fuel such as methanol, etc. without using a fuel reformer and is operated at an operating temperature less than 100° C. Therefore, it is advantageous in being suitable for use as a portable power supply or a small power supply.

The polymer electrolyte fuel cell includes a plurality of membrane electrode assemblies (MEA) composed of a polymer electrolyte membrane positioned at an anode electrode, at a cathode electrode, and between the anode electrode and the cathode electrode. It is manufactured in a stack structure by interposing a separator between the membrane electrode assemblies. The polymer electrolyte fuel cell manufactured in a stack structure is sold to a user or transported or stored for sale, by commonly performing an activation process. The activation process is referred to a process increasing the activity of the catalyst layer and the electrolyte membrane of the MEA so that the fuel cell stack can show its performance. The activation process is commonly performed in the latter half of the manufacturing process of the fuel cell stack. Also, the fuel cell stack completing the activation process is evaluated in view of its performance and is then released as an end product.

Meanwhile, if a manufacturer and/or a seller does not promptly sell a polymer electrolyte fuel cell to a final consumer after the polymer electrolyte fuel cell is manufactured, the membrane electrolyte assembly of the polymer electrolyte fuel cell, which is transporting or storing, becomes dehydrated to the point of being dry. The longer such a dry state exists, the characteristic develops that the membrane electrolyte assembly gradually fails. Therefore, the manufacturer and/or the seller has difficulty promptly selling the fuel cell to a consumer after the time point completing the manufacture of the fuel cell, for reliable sale of the fuel cell.

Also, the polymer electrolyte fuel cell has difficulties that the characteristic of the membrane electrode assembly promptly gradually fails due to the poisoning element of the catalyst layer, as the operation time is accumulated, and the performance of the fuel cell is promptly degraded thereby. The present embodiments overcome the above problems as well as provide additional advantages.

### SUMMARY OF THE INVENTION

It is an object of the present embodiments to provide a method and an apparatus for managing performance of a direct methanol type fuel cell stack, capable of setting a first activation time point of a manufactured stack to a user's use time point and recovering the performance degraded during long time use thereof.

It is another object of the present embodiments to provide a direct methanol type fuel cell system using the method for managing fuel cell performance.

In order to accomplish the objects, there is provided a method for managing performance of a direct methanol type fuel cell stack according to one aspect of the present embodiments, as a method for managing the performance of a fuel cell stack generating electric energy by means of the electrochemical reaction between fuel and an oxidant, the method including the steps of: receiving a first drive request signal or a performance recovery request signal; circulating high-concentration liquid fuel having higher density than fuel supplied to a stack through an anode flow of the fuel cell stack in response to the received request signal; and circulating water through the anode flow after stopping the circulation of the high-concentration liquid fuel.

Exemplarily, the method for managing performance of the direct methanol type fuel cell stack can further include the steps of stopping the supply of fuel to the anode flow of the fuel cell stack and stopping the supply of an oxidant to a cathode of the fuel cell stack.

The step of circulating the high-concentration liquid fuel is performed from about one hour to about two hours.

The step of circulating the water is performed for 10 minutes or more and 20 minutes or less.

The high-concentration liquid fuel includes aqueous methanol liquid fluid or pure methanol with concentration of about 2.0 molar or more. The high-concentration liquid fuel is exemplarily aqueous methanol liquid fluid of about 3.0 molar or more.

The fuel includes aqueous methanol liquid fluid of about 0.5 molar or more and about 2.0 molar or less.

The method for managing the performance of the direct methanol type fuel cell stack can further includes the steps of: supplying fuel and an oxidant to the fuel cell stack after stopping the circulation of water through the anode flow and electrically coupling load to the fuel cell stack; judging whether or not electric energy generated from the fuel cell stack is above setting value; and remaining a current driving mode, if the electric energy is above the setting value, and converting the current driving mode into an hybrid driving mode, if the electric energy is below the setting value.

The step of converting the current driving mode into the hybrid driving mode can include the step of: electrically coupling secondary power supply to the load and separating the fuel cell stack from the load; or electrically coupling the second power supply and the fuel cell stack to the load.

The setting value can be selected as value subtracting about 0.2V from the standard 0CV that is average value of the open circuit voltage (OCV) of unit cells of the fuel cell stack. On the other hand, the setting value can be selected as value reduced by about 30% from the standard output that the output of the fuel cell stack is preset.

There is provided an apparatus for managing performance of a direct methanol type fuel cell stack according to another aspect of the present embodiments, as an apparatus for managing the performance of a fuel cell stack manufactured for generating electric energy by means of the electrochemical reaction between fuel and an oxidant, the apparatus including: an input terminal receiving a first drive request signal or a performance recovery request signal; a signal processing unit generating a control signal for circulating water through an anode flow, after circulating high-concentration liquid fuel having higher density than fuel supplied to a stack through the anode flow of the fuel cell stack in response to the received request signal; a storing unit coupled to the signal processing unit and storing a series of information for first drive and performance recovery operation of the stack; and an output terminal sequentially applying control signals to a first driver circulating the high-concentration liquid fuel and a second driver circulating water.

Exemplarily, the signal processing unit compares the electric energy sensed from the fuel cell stack when starting the fuel cell stack with the setting value, and if the sensed electric energy is above the setting value, it allows an operating mode of the fuel cell to remain a fuel cell island operating mode, and if the sensed electric energy is below the setting value, it allows another control signal for converting the operating mode of the fuel cell into a fuel cell-secondary power supply hybrid operating mode to be generated.

There is provided an apparatus for managing performance of a direct methanol type fuel cell stack according to another aspect of the present embodiments, as an apparatus for managing the performance of a fuel cell system including a fuel cell stack having an electrolyte membrane and an anode electrode and a cathode electrode joined to both sides of the electrolyte membrane, a fuel supply apparatus having a raw material container storing high-concentration liquid fuel with higher density than the fuel used in the power generation of the fuel cell stack and coupled to the fuel cell stack, and a water supply apparatus coupled to the fuel cell stack, the apparatus including: a memory stored with a program; and a processor coupled to the memory and performing the program, wherein the processor performs a series of processes circulating the high-concentration liquid fuel through an anode flow of the fuel cell stack for a predetermined time in response to a first drive request signal or a performance recovery request signal by means of the program and then circulating water for a predetermined time.

Exemplarily, before the series of processes are performed by means of the program, and to separate the load from the fuel cell stack, the processor can first perform another series of processes to stop the supply of fuel and the supply of an oxidant to the fuel cell stack by answering the performance recovery request signal.

After the series of processes are performed by means of the program, the processor compares the electric energy sensed from the fuel cell stack when starting the fuel cell stack with the setting value, and if the sensed electric energy is above the setting value, it allows the operating mode of the fuel cell to remain a fuel cell island operating mode, and if the sensed electric energy is below the setting value, it allows the operating mode of the fuel cell to be converted into a fuel cell-secondary power supply hybrid operating mode.

There is provided a direct methanol type fuel cell according to another aspect of the present embodiments, the direct methanol type fuel cell including: a fuel cell stack generating electric energy by electrochemically reacting fuel and an oxidant; a fuel supply apparatus storing high-concentration liquid fuel having higher density than the fuel supplied to the stack and circulating the high-concentration liquid fuel through an anode flow of the fuel cell stack; a water supply apparatus circulating water through the anode flow of the fuel cell stack; and a control apparatus operating the fuel supply apparatus and the water supply apparatus in response to a first drive request signal or a performance recovery request signal.

Exemplarily, the direct methanol type fuel cell further includes a pipe for fluid transfer among the fuel cell stack, the fuel supply apparatus, and the water supply apparatus and a valve for managing the degree of opening and closing of the pipe, wherein the control apparatus can manage the valve in order to circulate the high-concentration liquid fuel through the anode flow of the fuel cell stack for a predetermined time and to circulate the water through the anode flow thereof for a predetermined time after stopping the circulation of the high-concentration liquid fuel.

There is provided a direct methanol type fuel cell according to another aspect of the present embodiments, the direct methanol type fuel cell including: a fuel cell stack generating electric energy by electrochemically reacting fuel and an oxidant; a fuel supply apparatus supplying high-concentration liquid fuel having higher density than the fuel implanted to the stack to an anode flow of the fuel cell stack; a water supply apparatus supplying water to the anode flow of the fuel cell stack; a fuel circulator receiving and storing unreacted fuel and moisture from the fuel cell stack, receiving and storing the high-concentration liquid fuel supplied from the fuel supply apparatus, and implanting the fuel to the anode flow of the fuel cell stack; a pipe for fluid transfer between any one of the fuel supply apparatus, the water supply apparatus and the fuel circulator, and the fuel cell stack, and a valve for managing the fluid transfer in the pipe; and a control apparatus controlling the fuel supply apparatus, the water supply apparatus, the fuel circulator, and the valve, wherein the control apparatus circulates the high-concentration liquid fuel through the anode flow of the fuel cell stack for a predetermined time in response to a first drive request signal or a performance recovery request signal and then circulates pure water.

Exemplarily, the control apparatus can first perform processes to stop the supply of fuel and the supply of an oxidant to the fuel cell stack in response to the performance recovery request signal and to separate load from the fuel cell stack.

The control apparatus compares the electric energy sensed from the fuel cell stack when starting the fuel cell stack with the setting value, and if the sensed electric energy is above the setting value, it allows an operating mode of the fuel cell to remain a fuel cell island operating mode, and if the sensed electric energy is below the setting value, it allows the operating mode of the fuel cell to be converted into a fuel cell-secondary power supply hybrid operating mode.

### BRIEF DESCRIPTION OF THE DRAWINGS

These and/or other embodiments and features will become apparent and more readily appreciated from the following description of certain exemplary embodiments, taken in conjunction with the accompanying drawing of which:

FIG. 1 is a block diagram of a direct methanol type fuel cell using a method of managing the performance of a fuel cell stack according to a first embodiment;

FIG. 2 is a flow chart showing a method of managing the performance of a fuel cell stack according to a first embodiment;

FIG. 3 is a block diagram of a direct methanol type fuel cell using a method of managing the performance of a fuel cell stack according to a second embodiment;

FIG. 4 is a flow chart showing a method of managing the performance of a fuel cell stack according to a second embodiment;

FIG. 5 is a block diagram of an apparatus of managing the performance of a fuel cell stack adoptable to a direct methanol type fuel cell according to a third embodiment; and

FIGS. 6 and 7 are graphs for explaining the output characteristics of a direct methanol type fuel cell adopting a method for managing the performance of a fuel cell stack according to the present embodiments.

### DETAILED DESCRIPTION OF EXEMPLARY EMBODIMENTS

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the embodiments are omitted for clarity. Also, like reference numerals refer to like elements throughout.

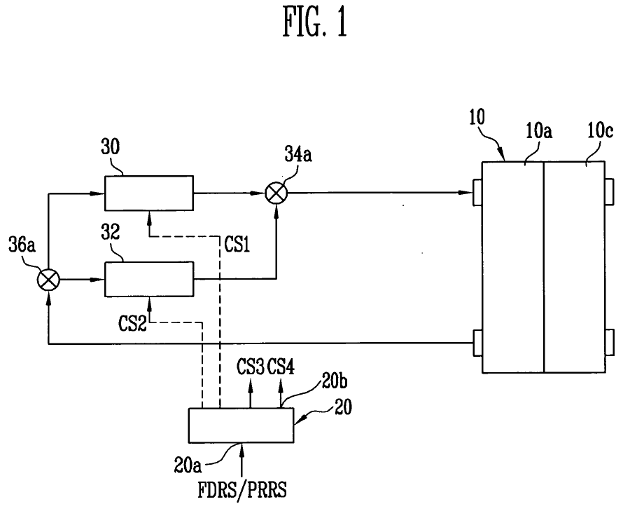

FIG. 1 is a block diagram of a direct methanol type fuel cell using a method of managing the performance of a fuel cell stack according to a first embodiment.

Referring to FIG. 1, the direct methanol type fuel cell according to the present embodiments includes a fuel cell stack 10, a control apparatus 20, a fuel supply apparatus 30, a water supply apparatus 32, and valves 34a and 36a.

The fuel cell stack 10 includes a membrane electrode assembly (MEA) having an anode electrode, a cathode electrode and an ion-exchange membrane positioned between the anode electrode and the cathode electrode. Also the fuel cell stack generates electricity using the fuel (substance containing hydrogen) supplied to the anode electrode 10a and the air (substance containing oxygen) supplied to the cathode electrode 10c.

Proton conductive polymer capable of being manufactured as the ion-exchange membrane (hereinafter, “electrolyte membrane”) includes, for example, fluoro-based polymer, ketonic polymer, benzimidazole-based polymer, ester-based polymer, amide-based polymer, imide-based polymer, sulfonic polymer, styrene-based polymer, hydro-carbonaceous polymer, etc. Some examples of the proton conductive polymer that may be used include one or more poly(perfluorosulfonic acid), poly(perfluorocarboxylic acid), tetrafluoroethylene including sulfonate group, fluorovinylether copolymer, defluorinated sulfide polyetherketone, aryl ketone, poly(2,2′-(m-phenylene)-5,5′-bibenzimidazole), poly(2,5-benzimidazole), polyimide, polysulfone, polystyrene, polypheneylene, etc. however, is the present embodiments are not limited thereto.

The catalyst layers 10a, 10c of the anode electrode and the cathode electrode includes at least one metal catalyst selected from a group consisting of platinum, ruthenium, osmium, alloy of platinum-ruthenium, alloy of platinum-osmium, alloy of platinum-palladium, and alloy of platinum-M (M is at least one transition metal selected from a group consisting of Ga, Ti, V, Cr, Mn, Fe, Co, Ni, Cu, and Zn). The catalyst may include at least one metal catalyst selected from a group consisting of platinum, ruthenium, osmium, alloy of platinum-ruthenium, alloy of platinum-osmium, alloy of platinum-palladium, and alloy of platinum-M (M is at least one transition metal selected from a group consisting of Ga, Ti, V, Cr, Mn, Fe, Co, Ni, Cu, and Zn), which are impregnated in a carrier. Any materials with conductivity can be used as the carrier, and in some embodiments, a carbon carrier can be used.

The diffusion layers of the anode 10a and the cathode 10c of the fuel cell stack 10 perform a function to support the respective electrode catalyst layers. They perform functions to diffuse the fuel, the water, and the air, etc., to collect the generated electricity, and to prevent the electrode catalyst layer material from losing. The diffusion layers can be implemented as a carbon substrate such as carbon cloth and carbon paper. A microporous layer can be coated on one surface of the respective diffusion layers (interface side with the electrode catalyst layers). The microporous layer performs a function so that fuel or an oxidant is evenly diffused and supplied to the respective electrode catalyst layers. The microporous layer on the cathode side performs a function so that the water generated from the electrode catalyst layer on the cathode side can smoothly be exhausted. The microporous layer can be implemented as a carbon layer. Also, the respective microporous layers may include at least one carbon material selected from a group consisting of graphite, carbon nano tube (CNT), fullerene (C60), activated carbon, vulcan, ketjen black, carbon black, and carbon nanohorn, and further include at least one binder selected from a group consisting of poly(perfluorosulfonic acid), poly(tetrafluoroethylene), and fluorinated ethylene-propylene.

The fuel cell stack 10 can be implemented in a manner that air is forcibly supplied to the cathode 10c by means of a power unit such as an air pump or a fan, or in a manner that air is supplied to the cathode 10c by means of air breathing.

The control apparatus 20 includes an input terminal 20a input with a first drive request signal (FDRS) or a performance recovery request signal (PRRS), and an output terminal 20b outputting control signals CS1, CS2, CS3, and CS4. The control apparatus 20 generates the control signals CS1 and CS2 in response to the first drive request signal (FDRS) to be input. The control apparatus 20 applies the generated first control signal CS1 to the fuel supply apparatus 30 and applies the generated second control signal CS2 to the water supply apparatus 32. The first drive request signal (FDRS) includes a user input signal for performing a conditioning or an activating of the MEA of the fuel cell stack 10 before starting the operation of the fuel cell. Herein, the conditioning or the activation includes a swelling process to soak the MEA of the stack in the fuel or the water for the first time, after the fuel cell stack 10 is manufactured.

Also, the control apparatus 20 generates the control signals CS1 and CS2 in response to the performance recovery request signal PRRS input during the operation of the fuel cell system. The control apparatus 20 applies the generated control signals CS1 and CS2 to the fuel supply apparatus 30 and the water supply apparatus 32. When the open circuit voltage of the fuel cell stack 10 is somewhat lowered during long time use of the fuel cell system, the performance recovery request signal PRRS can include the user input signal for performance (for example, OCV) recovery of the fuel cell stack.

The fuel supply apparatus 30 includes a means and an apparatus capable of supplying high concentration liquid fuel having higher density than the fuel used in the power generation of the fuel cell stack 10 in response to the control signal CS1 of the control apparatus to the anode 10a of the fuel cell stack 10. Herein, the fuel used in the power generation of the direct methanol type fuel cell stack is exemplarily within the range approximately of from about 0.5 molar to about 2.0 molar, in consideration of a crossover in case of aqueous methanol liquid fluid. The fuel supply apparatus 30 can be implemented to include a fuel container storing the high-concentration liquid fuel and a fuel pump capable of circulating the fuel stored in the fuel container through the anode 10a of the fuel cell stack 10. On the other hand, the fuel supply apparatus 30 supplies the high-concentration liquid fuel to the anode 10a of the fuel cell stack 10 by means of pressure of a pressing means. The fuel supply apparatus 30 can be implemented to include the fuel container storing the high-concentration liquid fuel exhausted from the anode 10a.

The water supply apparatus 32 stores pure water, and includes a means and an apparatus capable of supplying the pure water to the anode 10a of the fuel cell stack 10 in response to the control signal Cs2 of the control apparatus 20. The water supply apparatus 32 can be implemented to include a water container storing water and a liquid pump capable of circulating the water stored in the water container through the anode 10a of the fuel cell stack 10. Also, the water supply apparatus 32 supplies the water to the anode 10a of the fuel cell stack 10 by means of the pressure of the existing pressing means. Therefore, the water supply apparatus 32 can be implemented to include the water container storing the water exhausted from the anode 10a. As the pressing means, an apparatus configured of a pressure container storing inert gas and a pressure control apparatus controlling gas exhausting pressure of the pressure container/pressure of the pressure container to exhaust gas can be used.

The first valve 34a selectively or sequentially allows or blocks the supply of fuel from the fuel supply apparatus 30 to the fuel cell stack 10 or the supply of water from the water supply apparatus 32 to the fuel cell stack 10 in response to the third control signal CS3 of the control apparatus 20. The second valve 36a answers the fourth control signal CS4 of the control apparatus 20. In other words, the second valve 36a selectively connect or block the flow of a pipe disposed between the anode 10a of the fuel cell stack 10 and the fuel supply apparatus 30 in order that the high-concentration liquid fuel exhausted through the anode 10a of the fuel cell stack 10 is implanted again into the fuel supply apparatus 30. Otherwise, the second valve 36a selectively connects or blocks the flow of the pipe disposed between the anode 10a of the fuel cell stack 10 and the water supply apparatus 32 in order that the pure water exhausted through the anode 10a of the fuel cell stack 10 is implanted again into the water supply apparatus 32.

Meanwhile, when methanol is used as fuel in the fuel cell stack using solid polymer as the electrolyte membrane, the methanol easily crossovers the solid polymer electrolyte membrane. Therefore, the fuel utilization of the system is deteriorated and the methanol reached at the cathode 10c is oxidated to lower cathode potential so that the output characteristic of the stack lowers. Therefore, even in the case using optimal fuel density capable of obtaining optimal performance, the output characteristic of the fuel cell stack 10 lowers, as the use number thereof increases. However, the fuel cell stack can periodically reactivated with the performance management method of the present embodiments, making it possible to obtain effects to extend a lifetime together with the performance recovery of the stack.

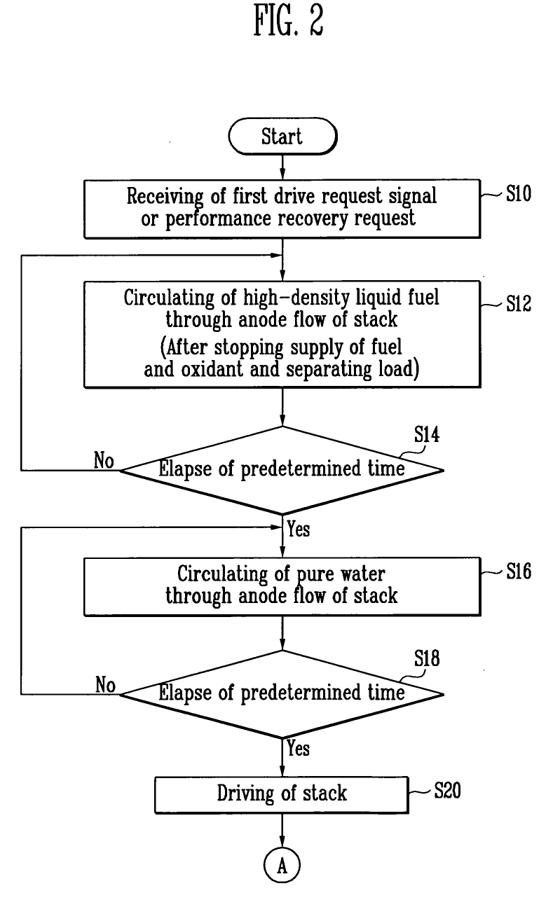

The operation principle of the direct methanol type fuel cell system will be described with reference to FIG. 2. FIG. 2 is a flow chart showing a method of managing the performance of a fuel cell stack according to a first embodiment.

Referring to FIG. 2, first the control apparatus mounted on a direct methanol type fuel cell system receives a first drive request signal or a performance recovery request signal to be input in a software manner or a hardware manner by a user or a user's operation (S10). Herein, the first drive request signal may be a system operation request signal including an activation process or a conditioning process of a fuel cell stack for a first drive of the fuel cell system. The performance recovery request signal may be a system operation request signal including a reactivation process of the fuel cell stack for a recovery of OCV during the use of the fuel cell system.

Next, the control apparatus generates control signals in response to the first drive request signal or the performance recovery request signal. The control apparatus sequentially applies the generated control signals to a fuel supply apparatus and a water supply apparatus at a predetermined time interval to first perform the activation process prior to a normal operation.

The control apparatus circulates high-concentration liquid fuel through an anode flow of the fuel cell stack (S12). At this time, if the input request signal is the first drive request signal or is not the performance recovery request signal input in the system operation-stop state (the performance recovery request signal input in the system operation state), the control apparatus first stops the supply of low-concentration liquid fuel to an anode and stops the supply of an oxidant to a cathode, and then performs the step (S12). Herein, high-concentration liquid fuel is referred to fuel having higher density than the fuel supplied to the fuel cell stack. For example, in case of aqueous methanol liquid fluid in which the fuel supplied to the fuel cell stack is from about 0.5 molar to about 2.0 molar, the high-concentration liquid fuel includes the aqueous methanol liquid fluid having density exceeding about 2.0 molar or pure methanol. Similarly, the low-concentration liquid fuel, which is the fuel having lower density than the high-concentration liquid fuel, is referred to the fuel implanted to the fuel cell stack. In the present embodiment, the methanol exemplarily uses the aqueous methanol liquid fluid exceeding about 2.0 molar or pure methanol as the high-concentration liquid fuel. If aqueous methanol liquid fluid of about 2.0 molar or less is used, the performance recovery time of the fuel cell stack exceeds about two hours to have a disadvantage that the performance recovery time lengthens.

Next, it is judged whether the circulation of the high-concentration liquid fuel is performed for a predetermined time through the anode of the fuel cell stack (S14). The step limits minimum application time for promptly and excellently activating the anode electrode, the cathode electrode and the electrolyte membrane with the high-concentration liquid fuel. The minimum application time is one hour, and the minimum application time may be from about one hour to about two hours depending on the structure or the size of the fuel cell stack.

Next, the control apparatus stops the circulation of the high-concentration liquid fuel and then circulates pure water for a predetermined time through the anode flow of the fuel cell stack (S16 and S18). The present step includes a process for washing the previously supplied high-concentration liquid fuel from the fuel cell stack for a safe and smooth start of the fuel cell stack. The circulation time of the pure water is set to the time suitable for clearly washing the high-concentration liquid fuel, not taking too much time in the present performance management process. For example, the time is exemplarily set to the range of 10 minutes to 20 minutes.

After the steps, the control apparatus supplies the fuel to the anode of the fuel cell stack and supplies the oxidant to the cathode to drive the fuel cell stack (S20).

The method of managing the performance of the fuel cell stack according to the first embodiment and the direct methanol type fuel cell adopting this method can be applied to an existing direct methanol type fuel cell system having various structures. For example, they can be applied as a second embodiment to be explained below.

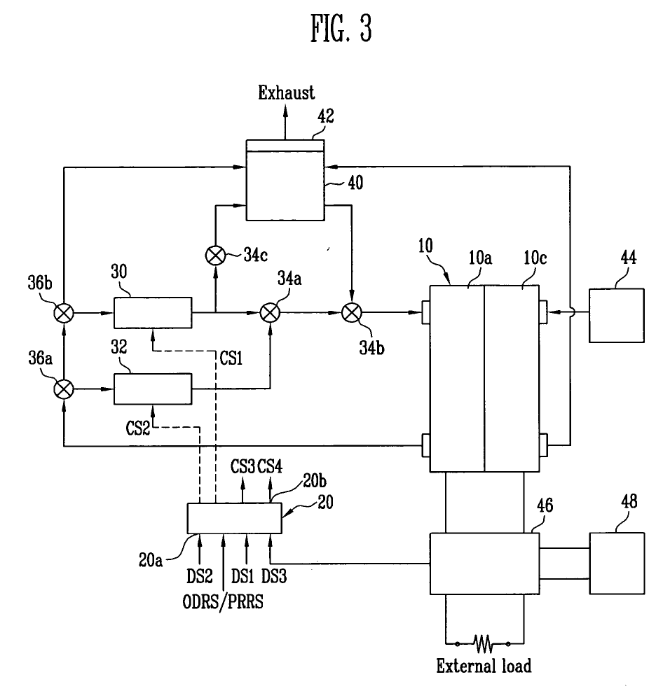

FIG. 3 is a block diagram of a direct methanol type fuel cell using a method of managing the performance of a fuel cell stack according to a second embodiment.

Referring to FIG. 3, the direct methanol type fuel cell according to the present embodiment includes a fuel cell stack 10, a control apparatus 20, a fuel supply apparatus 30, a water supply apparatus 32, valves 34a, 34b, 34c, 36a and 36b, a fuel circulation apparatus 40, a gas-liquid separator 42, an oxidant supply apparatus 44, a power conversion apparatus 46, and a secondary power supply 48.

The first valve 34a is a 3-port valve and includes two inlets each coupled to the fuel supply apparatus 30 and the water supply apparatus 32 and an outlet facing the fuel cell stack 10. The third valve 34b is a 3-port valve and includes a first inlet coupled to the outlet of the first valve 34a and an outlet coupled to an inlet of an anode 10a of the fuel cell stack 10. The fourth valve 34c is a 2-port valve and includes an inlet coupled to the fuel supply apparatus 30 and an outlet coupled to the fuel circulation apparatus 40. The second valve is a 3-port valve and includes an inlet coupled to the outlet of the anode 10a of the fuel cell stack 10 and a first outlet coupled to the water supply apparatus 32. The fifth valve 36b is a 3-port valve and includes an inlet coupled to another outlet (second outlet) of the second valve 36a, a first outlet coupled to the fuel supply apparatus 30, and a second outlet coupled to the fuel circulation apparatus 40. The first to fifth valves 34a, 34b, 34c, 36a, and 36b include mechanical valve themselves and an operator controlling the operation of the valves. The first to fifth valves 34a, 34b, 34c, 36a, and 36b operate to properly open or close the degree of opening of the valves by means of the control signals CS3 and CS4 of the control apparatus 20.

The fuel circulation apparatus 40 receives unreacted fuel, moisture and byproducts exhausted from the anode 10a and/or cathode 10c of the fuel cell stack 10 and stores reacted fuel and water. Also, the fuel circulation apparatus 40 receives and stores the high-concentration liquid fuel from the fuel supply apparatus 30. The fuel circulation apparatus 40 supplies the stored fuel aqueous liquid fluid to the anode 10a of the fuel cell stack 10. A heat exchanger and a condenser can be installed between the fuel cell stack 10 and the fuel circulation apparatus 40 for improving fuel efficiency and managing water and heat in the system. Such a heat exchanger or condenser recovers the heat energy of the fluid exhausted from the fuel cell stack 10. The heat exchanger or the condenser can be installed in a shape that is directly coupled to the fuel circulation apparatus 40. The fuel circulation apparatus 40 can be implemented as a mixing tank for storing the fluid to be flowed in and a pump for exhausting the fluid stored in the mixing tank.

The gas-liquid separator 42 includes an apparatus separating and exhausting byproducts among the fluid exhausted from the fuel cell stack 10. When using aqueous methanol liquid fluid as fuel, the byproducts include carbon dioxide as shown in the following reaction formula 1.

Anode: CH₃OH+H₂O→CO₂+6H⁺+6e⁻ [Reaction Formula 1]

Cathode: 3/2O₂+6H⁺+6e⁻→3H₂O

The whole: CH₃OH+3/2O₂→CO₂+3H₂O

The gas-liquid separator 42 can be implemented to include a gas-liquid separating means for separating gas from moisture, a trap storing moisture, and a ventilation hole for exhausting carbon dioxide, etc. Of course, the gas-liquid separator 42 can be implemented to include a back pressure valve for pressure and automatic drainage inside thereof.

The oxidant supply apparatus 44 includes a means and an apparatus for supplying an oxidant to the cathode 10c of the fuel cell stack 10. As the oxidant, air containing oxygen or pure oxygen can be used. As the oxidant supply apparatus 44, an air pump, a blower, and a fan, etc. can be used. Meanwhile, when the fuel cell system adopts the fuel cell stack 10 in an air breathing manner supplied with air in the atmosphere by means of natural convection, the oxidant supply apparatus 44 can be omitted.

The power conversion apparatus 46 converts the electricity generated from the fuel cell stack 10 to a suitable shape to supply it to external load. The power conversion apparatus 46 includes a means and an apparatus converting direct current electricity to alternating current electricity or converting the direct current electricity into direct current electricity in another shape and size. Otherwise, the power conversion apparatus 46 includes a means and an apparatus converting direct current electricity to alternating current electricity. For example, the power conversion apparatus 46 can be implemented to include at least any one of an analog-digital convert (ADC), a digital-analog converter (DAC), and a digital-digital converter. Also, a current sensor or a voltage sensor for measuring the current or the voltage output from the fuel cell stack 10 can be installed in the power conversion apparatus 46.

The secondary power supply 48 includes a means and an apparatus capable of supplying electricity to the external load or supplying electricity to the balance of plants of the fuel cell system, together with the fuel cell stack 10 or independently. For example, the secondary power supply 48 includes a rechargeable secondary cell and a power supply apparatus mountable on the fuel cell system such as a capacitor or a supercapacitor. On the other hand, the secondary power supply 48 includes a power supply apparatus such as another fuel cell system or commercial power supply, etc.

The control apparatus 20 generates control signals CS1, CS2, CS3, and CS4 in response to a first drive request signal (FDRS) or a performance recovery request signal (PRRS) to be input. The control apparatus 20 controls the fuel supply apparatus 30 and the water supply apparatus 32 with some generated control signals CS1 and CS2, and controls the valves 34a, 34b, 34c, 36a, and 36b with another generated control signals CS3 and CS4. Also, the control apparatus 20 senses various information of the fuel cell stack 10 by means of detection signals DS1, DS2, and DS3 input to an input terminal 20a, through a sensor mounted on the power conversion apparatus 46. For example, the control apparatus 20 senses information on output current or output voltage, information on a state of charge (SOC) of the secondary power supply 48, information on the fuel level stored in the fuel circulation apparatus 40, and information relating to another systems operation. The control apparatus 20 can generate another control signal for controlling the balance of plants mounted on the system in order to operate the system based on the sensed information. The balance of plants includes a heat exchanger, a condenser, a pump, a sensor, an indicator, and a speaker, etc.

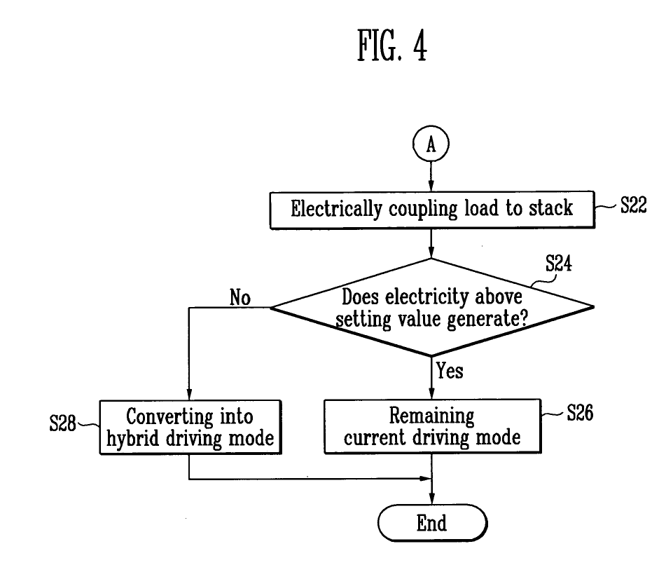

The operation principle of the direct methanol type fuel cell system will be described with reference to FIG. 4. FIG. 4 is a flow chart showing a method of managing the performance of a fuel cell stack according to a second embodiment.

Referring to FIGS. 2 and 4, if a performance recovery request signal is received during the operation of the fuel cell system (S10), a control apparatus first blocks the supply of fuel from a fuel circulation apparatus to the fuel cell stack and blocks the supply of oxidant from an oxidant supply apparatus to the fuel cell stack. The control apparatus electrically separates the external load coupled to the fuel cell stack and then controls valves and apparatuses so that high-concentration liquid fuel (for example, aqueous methanol liquid fluid of about 3.0 molar) circulates from the fuel supply apparatus, for an hour, through an anode of the fuel cell stack (S12 and S14).

Next, the control apparatus controls the valves and the apparatuses so that pure water circulates from the water supply apparatus, for 10 minutes, through the anode of the fuel cell stack (S16 and S18).

Next, the control apparatus operates to supply fuel to the anode of the fuel cell stack by means of the fuel circulation apparatus and to supply an oxidant to the cathode of the fuel cell stack by means of the oxidant supply apparatus so that it starts the fuel cell stack (S20).

Next, the control apparatus electrically connects load to the fuel cell stack, after the starting of the fuel cell stack (S22). The control apparatus detects the current and/or voltage generated from the fuel cell stack. The control apparatus compares the detected current value and/or voltage value with setting value to judge whether the detected value is above the setting value (S24). Herein, the setting value is a condition for normally starting the fuel cell stack. The setting value can be selected as value subtracting about 0.2V from a standard OCV, which is the average value of OCV of unit cells, or as value that a standard output performance set when the fuel cell stack is designed is approximately reduced by about 30%.

As a result of judging the step S24, if the detected value is above the setting value, the control apparatus remains a current driving mode (S26). Meanwhile, as a result of judging the step 24, if the detected value is not above the setting value, the control apparatus converts the system into a hybrid driving mode so that the electric energy of the secondary power supply is supplied to the external load independently or together with the fuel cell stack (S28). After the first drive or the performance recovery process of the fuel cell stack is performed according to the steps S24, S26 and S28, the safe starting of the stack is possible.

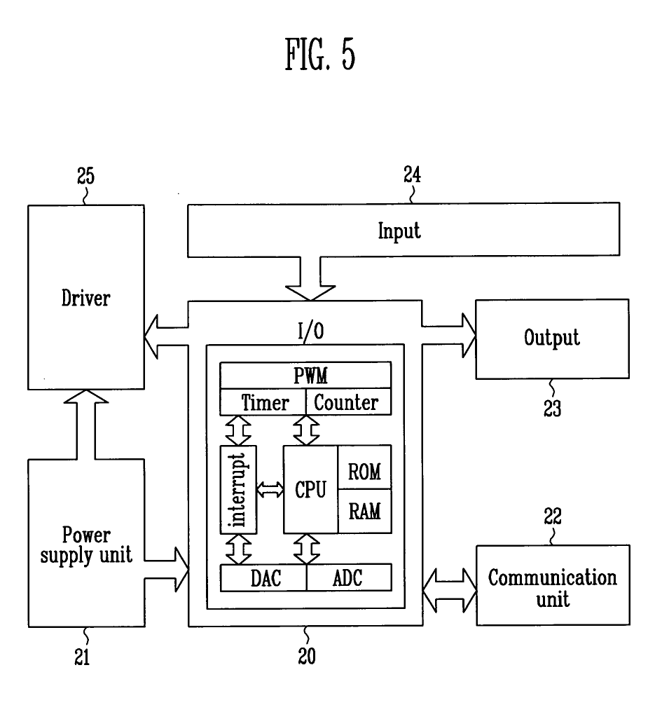

FIG. 5 is a block diagram of an apparatus of managing the performance of a fuel cell stack adoptable to a direct methanol type fuel cell according to a third embodiment.

The apparatus for managing the performance of the fuel cell stack according to the third embodiment can be implemented to include at least a partial functioning unit of a microprocessor operated by means of the information and/or program stored in a memory and a logic circuit using a flip-flop. A control apparatus, which is a main constituent of the performance management apparatus and is implemented as the microprocessor, will be described in detail below. In the description of the third embodiment, the control apparatus can correspond to the control apparatus mounted on the direct methanol type fuel cell system of the present embodiments as described above.

Referring to FIG. 5, the control apparatus according to the third embodiment includes a memory system, and at least one central processing unit (CPU) coupled to the memory system to perform a high-speed operation.

The central processing unit includes an arithmetic logic unit (ALU) for performing a calculation, a register for temporarily storing data and commands, and a controller for controlling the first drive and the performance recovery operation of the fuel cell stack. The central processing unit includes at least one processor with various architectures such as, for example, Alpha of Digital company, MIPS of MIPS Technology, NEC, IDT, and Siemens companies, etc., x86 of Intel, Cyrix, AMD, and Nexgen companies, etc., PowerPC of IBM and Motorola companies, and ARM of ARM company.

The memory system generally includes a high-speed main memory, an auxiliary memory 33, and a recording apparatus. As the storage medium shapes of the high-speed main memory, there are a random access memory (RAM) and a read only memory (ROM). Examples of the long time storage medium shape of the auxiliary memory 33, include a floppy disk, a hard disk, a magnetic tape, a CD-ROM, and a flash memory, etc. The recording apparatus stores data using electricity, magnetism, optics, and other storage medium. The memory system can include a video memory displaying an image through a display apparatus.

Also, the control apparatus 20 includes an input terminal for a signal input 24 and an output terminal for a signal output 23. The input terminal and the output terminal I/O can be implemented as an analog-digital converter (ADC), a digital-analog converter (DAC), and an input and output ports, etc. The signal input 24 includes the input from a keyboard, a mouse, and a touchpad to the control apparatus, and the signal output 23 includes the output from the control apparatus to the display apparatus and the speaker. Also, the input and output of the signal from the control apparatus 20 can be transmitted and received in a wire and wireless communication manner through a communication unit 22.

Also, the control apparatus 20 includes an interrupt for interrupting a signal processing, and a pulse width modulation (PWM), a timer, and a counter as other constituents.

The control apparatus 20 receives power from a power supply unit 21 including a secondary power supply such as a secondary cell, etc. The control apparatus 20 controls a driver 25 in response to a first drive request signal or a performance recovery request signal to be input and then performs the performance management method of the fuel cell stack of the present embodiments as described above. Meanwhile, the memory system as described above can be mounted on the control apparatus 20 or can separately be mounted, and it corresponds to a storage unit storing a series of information for performing the first drive and the performance recovery operation. The control apparatus 20 corresponds to a signal processing unit generating control signals for performing the performance management method of the fuel cell stack of the present embodiments.

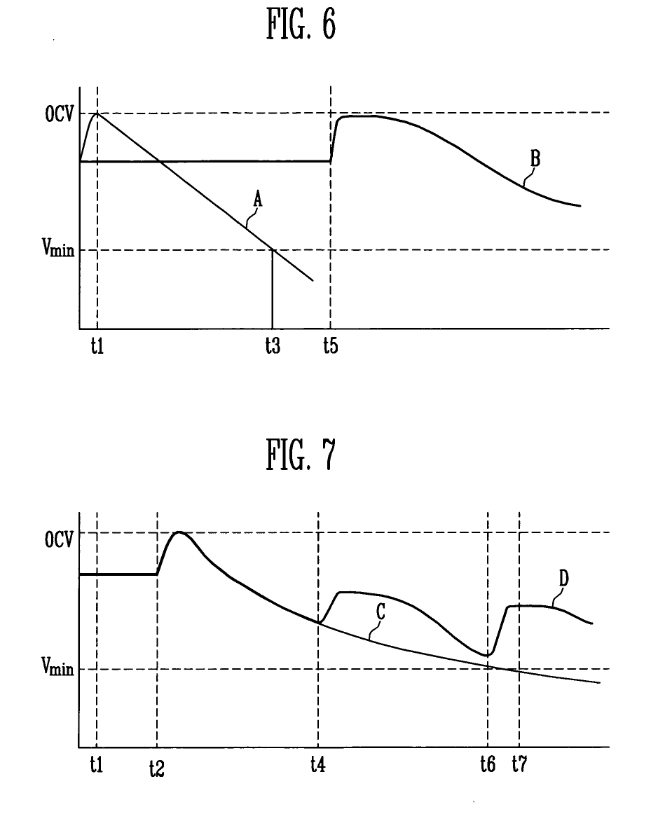

FIG. 6 is a graph showing the output characteristic of a direct methanol type fuel cell adopting a method for managing the performance of a fuel cell stack according to the present embodiments.

As shown in FIG. 6, a graph A shows the case of prior direct methanol type fuel cell released after being subject to a process activation at a certain time point t1 when the fuel cell system is manufactured. In this case, the graph A shows that as the transport and storage time of the fuel cell becomes long before being sold to a user, it is converted to a product not capable of producing even lowest output voltage Vmin after a certain time point t3. Herein, the lowest output voltage Vmin represents the voltage that the fuel cell system can be used as a product.

Meanwhile, a graph B shows the case of the direct methanol type fuel cell of the present embodiments released not being subject to the process activation when the fuel cell system is manufactured. In this case, the graph B shows that the fuel cell spontaneously performs the activation in response to the user's first drive request signal at a certain time point t5 and then operates. Herein, the certain time points t3 and t5 can have the relation of t3>t5 or t3=t5, other than the relation of t3<t5.

Therefore, with the present embodiments, the release time and the transport and sale periods of the end product of the fuel cell system can be extended to have effects to provide convenience to a product manufacturer and a seller in product management.

FIG. 7 is a graph showing another output characteristic of a direct methanol type fuel cell adopting a method for managing the performance of a fuel cell stack according to the present embodiments.

As shown in FIG. 7, a graph C shows the case of a direct methanol type fuel cell being subject to activation at the time point of manufacturing the fuel cell system or at a user's use time point t2. In this case, the graph C shows that as the operation time of the fuel cell system is accumulated, the performance of the system is degraded and OCV reaches at lowest output voltage Vmin at a certain time point t6 so that the fuel cell system cannot be further used as a product.

Meanwhile, a graph D shows the case of a direct methanol type fuel cell being subject to activation at the time point of manufacturing the fuel cell system or at a user's use time point t2. In this case, the graph D shows that by applying the performance management method of the stack of the present embodiments, the fuel cell can partially recover the OCV though a performance recovery action at a certain time point t4 when the performance of the system is degraded. Also, the graph D shows that when the performance of the system is degraded again, the fuel cell operates, while partially recovering the OCV again through the performance recovery action at a certain time point t6. Therefore, the present embodiments have effects to extend the lifetime of the direct methanol type fuel cell.

As described above, the present embodiments can extend the transport and storage periods of the manufacturer and the seller of the fuel cell by managing the activation time point of the fuel cell stack to the final user's use time point of the fuel cell. Also, the present embodiments have an advantage capable of spontaneously recovering the performance of the stack degraded due to the long time use of the fuel cell. Furthermore, the present embodiments have advantages to improve the performance of the direct methanol type fuel cell used in a portable electronic device such as a notebook computer, a portable multimedia player (PMP), a personal digital assistant (PDA), and a cellular phone, etc., and to extend the lifetime thereof.

The present embodiments can extend the performance of the direct methanol type fuel cell system as well as the lifetime of the system. Furthermore, the present embodiments can provide time for the transport and storage of the manufactured fuel cell to a seller. Also, the present embodiments can provide the fuel cell having even performance and reliability to the user. Also, the present embodiments can spontaneously recover the degraded performance of the fuel cell to have an advantage that the user's convenience increases.

Although exemplary embodiments have been shown and described, it would be appreciated by those skilled in the art that changes might be made in these embodiments without departing from the principles and spirit of the embodiments, the scope of which is defined in the claims and their equivalents.

What is claimed is:

1. A method for managing performance of a direct methanol type fuel cell stack, wherein the fuel cell stack is configured to generate electric energy by means of the electrochemical reaction between fuel and an oxidant, the method comprising the steps of:
receiving a first drive request signal or a performance recovery request signal;
circulating high-concentration liquid fuel having a higher density than fuel supplied to the stack through an anode flow of the fuel cell stack in response to the received request signal;
stopping the circulation of the high-concentration liquid fuel; and
circulating water through the anode flow after stopping the circulation of the high-concentration liquid fuel.

2. The method for managing performance of a direct methanol type fuel cell as claimed in claim 1, further including the steps of stopping the supply of fuel to the anode flow of the fuel cell stack and stopping the supply of an oxidant to a cathode of the fuel cell stack.

3. The method for managing performance of a direct methanol type fuel cell as claimed in claim 1, wherein the step of circulating the high-concentration liquid fuel is performed from about one hour to about two hours.

4. The method for managing performance of the direct methanol type fuel cell as claimed in claim 1, wherein the step of circulating the water is performed for 10 minutes or more and 20 minutes or less.

5. The method for managing performance of the direct methanol type fuel cell as claimed in claim 1, wherein the high-concentration liquid fuel includes an aqueous methanol liquid fluid or pure methanol with concentration exceeding about 2.0 molar.

6. The method for managing performance of the direct methanol type fuel cell as claimed in claim 1, wherein the fuel includes aqueous methanol liquid fluid of from about 0.5 molar to about 2.0 molar.

7. The method for managing performance of the direct methanol type fuel cell as claimed in claim 1, further including the steps of:
stopping the circulation of water through the anode flow;
supplying fuel and an oxidant to the fuel cell stack after stopping the circulation of water through the anode flow and electrically coupling load to the fuel cell stack;
judging whether or not electric energy generated from the fuel cell stack is above setting value; and
maintaining a current driving mode, if the electric energy is above the setting value, and converting the current driving mode into an hybrid driving mode, if the electric energy is below the setting value.

8. The method for managing performance of the direct methanol type fuel cell as claimed in claim 7, wherein the step of converting the current driving mode into the hybrid driving mode comprising the step of: electrically coupling a secondary power supply to the load; or electrically coupling the second power supply and the fuel cell stack to the load.

9. The method for managing performance of the direct methanol type fuel cell as claimed in claim 7, wherein the setting value is selected as value subtracting about 0.2V from the standard open circuit voltage that is average value of the open circuit voltage of unit cells of the fuel cell stack, or is selected as value reduced by about 30% from the output of the fuel cell stack.

10. The method for managing performance of the direct methanol type fuel cell as claimed in claim 1, wherein the first drive request signal includes a signal for a first activation after the fuel cell stack is manufactured.

11. An apparatus for managing performance of a direct methanol type fuel cell stack comprising an apparatus for managing the performance of a fuel cell stack manufactured for generating electric energy by means of the electrochemical reaction between fuel and an oxidant, the apparatus comprising:
an input terminal receiving a first drive request signal or a performance recovery request signal;
a signal processing unit generating a control signal for circulating water through an anode flow after circulating high-concentration liquid fuel having higher density than fuel supplied to a stack through the anode flow of the fuel cell stack in response to the received request signal;
a storing unit coupled to the signal processing unit and storing a series of information for first drive and performance recovery operation of the stack; and
an output terminal configured to sequentially apply control signals to a first driver circulating the high-concentration liquid fuel and a second driver circulating water.

12. The apparatus for managing performance of the direct methanol type fuel cell stack as claimed in claim 11, wherein the signal processing unit compares the electric energy sensed from the fuel cell stack when starting the fuel cell stack with the setting value, and if the sensed electric energy is above the setting value, it allows an operating mode of the fuel cell to maintain a fuel cell island operating mode, and if the sensed electric energy is below the setting value, it allows another control signal for converting the operating mode of the fuel cell into a fuel cell-secondary power supply hybrid operating mode to be generated.

13. An apparatus for managing performance of a direct methanol type fuel cell stack, comprising an apparatus for managing the performance of a fuel cell system comprising a fuel cell stack having an electrolyte membrane and an anode electrode and a cathode electrode joined to both sides of the electrolyte membrane,
a fuel supply apparatus having a raw material container storing high-concentration liquid fuel with higher density than the fuel used in the power generation of the fuel cell stack and coupled to the fuel cell stack, and
a water supply apparatus coupled to the fuel cell stack, the apparatus including:
a memory stored with a program; and
a processor coupled to the memory and performing the program,
wherein the processor is configured to perform a series of processes circulating the high-concentration liquid fuel through an anode flow of the fuel cell stack for a predetermined time in response to a first drive request signal or a performance recovery request signal by means of the program and then circulating water for a predetermined time.

14. The apparatus for managing performance of the direct methanol type fuel cell stack as claimed in claim 13, wherein before the series of processes are performed by means of the program, and to separate the load from the fuel cell stack, the processor first performs another series of processes to stop the supply of fuel and the supply of an oxidant to the fuel cell stack by answering the performance recovery request signal.

15. The apparatus for managing performance of the direct methanol type fuel cell stack as claimed in claim 13, wherein after the series of processes are performed by means of the program, the processor compares the electric energy sensed from the fuel cell stack when starting the fuel cell stack with the setting value, and if the sensed electric energy is above the setting value, it allows the operating mode of the fuel cell to maintain a fuel cell island operating mode, and if the sensed electric energy is below the setting value, it allows the operating mode of the fuel cell to be converted into a fuel cell-secondary power supply hybrid operating mode.

16. The apparatus for managing performance of the direct methanol type fuel cell stack as claimed in claim 13, wherein the first drive request signal includes a signal for a first activation after the fuel cell stack is manufactured.

17. A direct methanol type fuel cell including:
a fuel cell stack configured to generate electric energy by electrochemically reacting fuel and an oxidant;
a fuel supply apparatus storing high-concentration liquid fuel having higher density than the fuel supplied to a stack through an anode flow and circulating the high-concentration liquid fuel through an anode flow of the fuel cell stack;
a water supply apparatus circulating water through the anode flow of the fuel cell stack; and
a control apparatus operating the fuel supply apparatus and the water supply apparatus in response to a first drive request signal or a performance recovery request signal.

18. The direct methanol type fuel cell as claimed in claim 17, further including a pipe for fluid transfer among the fuel cell stack, the fuel supply apparatus, and the water supply apparatus and a valve for managing the degree of opening and closing of the pipe,
wherein the control apparatus can manage the valve in order to circulate the high-concentration liquid fuel through the anode flow of the fuel cell stack for a predetermined time and to circulate the water through the anode flow thereof for a predetermined time after stopping the circulation of the high-concentration liquid fuel.

19. A direct methanol type fuel cell including:
a fuel cell stack configured to generate electric energy by electrochemically reacting fuel and an oxidant;
a fuel supply apparatus configured to supply high-concentration liquid fuel having higher density than the fuel implanted to the stack to an anode flow of the fuel cell stack;
a water supply apparatus configured to supply water to the anode flow of the fuel cell stack;
a fuel circulator configured to receive and store unreacted fuel and moisture from the fuel cell stack, receive and store the high-concentration liquid fuel supplied from the fuel supply apparatus, and implant the fuel to the anode flow of the fuel cell stack;
a pipe for fluid transfer between any one of the fuel supply apparatus, the water supply apparatus and the fuel circulator, and the fuel cell stack, and a valve for managing the fluid transfer; and
a control apparatus configured to control the fuel supply apparatus, the water supply apparatus, the fuel circulator, and the valve,
wherein the control apparatus is configured to circulate the high-concentration liquid fuel through the anode flow of the fuel cell stack for a predetermined time in response to a first drive request signal or a performance recovery request signal and then circulate pure water.

20. The direct methanol type fuel cell as claimed in claim 19, wherein the control apparatus first performs processes to stop the supply of fuel and the supply of an oxidant to the fuel cell stack in response to the performance recovery request signal and to separate load from the fuel cell stack.

21. The direct methanol type fuel cell as claimed in claim 19, wherein the control apparatus compares the electric energy sensed from the fuel cell stack when starting the fuel cell stack with the setting value, and if the sensed electric energy is above the setting value, it allows an operating mode of the fuel cell to remain a fuel cell island operating mode, and if the sensed electric energy is below the setting value, it allows the operating mode of the fuel cell to be converted into a fuel cell-secondary power supply hybrid operating mode.

22. The direct methanol type fuel cell as claimed in claim 21, wherein the setting value is the value reduced by about 30% from the output of the fuel cell stack.

23. The direct methanol type fuel cell as claimed in claim 19, wherein the first drive request signal is a signal for a first activation after the fuel cell stack is manufactured.
